(19) United States
(12) Patent Application Publication
(10) Pub. No.: US 2026/0184525 A1
(43) Pub. Date: Jul. 2, 2026

(54) ADHESIVE TAPE CUTTING JIG ASSEMBLY

(71) Applicant: Stephina Johanna Heath, Perth (AU)

(72) Inventor: Stephina Johanna Heath, Perth (AU)

(21) Appl. No.: 19/160,815

(22) PCT Filed: Apr. 12, 2025
(86) PCT No.: PCT/AU2025/050363

§ 371 Date: Aug. 28, 2025

(30) Foreign Application Priority Data
Apr. 18, 2024 (AU) 2024901098

(51) Int. Cl. B65H 16/02; B65H 16/06; B65H 35/00

(52) U.S. Cl. CPC B65H 16/021; B65H 16/06; B65H 35/0066; B65H 2301/41306; B65H 2301/41342; B65H 2301/5154; B65H 2701/377

(57) ABSTRACT

Provided is an adhesive tape cutting jig assembly 10 comprising a body 12 configured to receive at least one roll of tape 14 rotatably therein, said body 12 defining at least one race 16 extending along a direction in which said roll 14 is unspoolable, and at least one tape carriage 18 slidably engaged with said race 16 and arranged to extend distally from said body 12, in use. The tape carriage 18 generally defines at least two protruding gantry members 20 on which the unspooled tape 22 is adherable so that a cutting tool 24 is freely-passable between said gantry members 20 to cut said unspooled tape 22 to provide a plurality of lengths of tape simultaneously

### TECHNICAL FIELD

This invention relates broadly to adhesive tape and tape dispensers, and more specifically to an adhesive tape cutting jig assembly and an associated method of cutting adhesive tape.

### BACKGROUND ART

The following discussion of the background art is intended to facilitate an understanding of the present invention only. The discussion is not an acknowledgement or admission that any of the material referred to is or was part of the common general knowledge as at the priority date of the application.

As is known in the art, a tape dispenser is generally an object that holds a roll of tape and has a mechanism at one end to shear the tape, such as a serrated blade. Such tape dispensers are frequently used to hold a roll of tape in a body thereof which allows a user to pull a desired length of tape from the roll and to tear the tape off for use as desired.

Advances on such conventional manually-operated tape dispensers generally include automated dispensers typically with electrical assists to measure, cut and dispense predetermined lengths of tape automatically. Examples of such conventional automated adhesive tape dispensers have been identified, such as described in Korean patent no. 10-2024720 in the name of Motex Co., Korean patent no. 10-1509124 to Choi Chahyeon and Korean patent application no. 10-2002-0000154 (published as KR 20030059860) to Jang San-Bin.

Such conventional automated tape dispensers all comprise a supply roller from which tape is dispensed from one roll of tape onto a guide roller having radially-projecting arms or fingers that interact with another cutting roller with blades that fit in-between such projecting arms or fingers as the respective rollers rotate to cut the tape on the guide roller into fixed lengths. The rollers are typically electrically-actuated for ease of use when dispensing lengths of tape from a roll, but must at least be mechanically coupled to ensure the respective rollers interact as planned.

Inherently, such conventional automated tape dispensers are generally mechanically complex devices to realise, requiring various parts with interacting electrical and/or mechanical components, making these conventional dispensers difficult to engineer and produce, as well as expensive to manufacture. Such complexity of interacting mechanisms further introduces various potential points of failure, and these devices all still dispense tape from a single roll of tape, which can lead to inefficiencies in activities requiring adhesive tape.

For example, as anyone that has ever wrapped presents or covered schoolbooks can attest to, having to work with single lengths of dispensed tape can be both time consuming and arduous, especially where one hand is required to hold work in place whilst the other is used to retrieve tape from a conventional dispenser, albeit manual or automatic.

In light hereof, Applicant has identified a need in the art for simple, elegant and inexpensive means whereby a plurality of lengths of tape is simultaneously presentable to a user when engaged in handicrafts, such as wrapping presents, covering schoolbooks, arts, etc. and the current invention was conceived with this goal in mind.

### SUMMARY OF THE INVENTION

According to a first aspect of the invention there is provided an adhesive tape cutting jig assembly comprising: a body configured to receive at least one roll of tape rotatably thereby, said body defining at least one race extending along a direction in which said roll is unspoolable; and
at least one tape carriage slidably engaged with said race and arranged to extend distally from said body, in use, the tape carriage defining at least two protruding gantry members on which the unspooled tape is adherable so that a cutting tool is freely-passable between said gantry members to cut said unspooled tape to provide a plurality of lengths of tape simultaneously.

In an embodiment, the body defines opposed slots for receiving ends of a spindle of a tape roll therein so that the roll is rotatable to unspool the tape.

In an embodiment, the body is configured to receive a plurality of rolls of tape arranged abreast.

In an embodiment, the body defines at least one protruding gantry member on which unspooled tape is receivable.

In an embodiment, at least one protruding gantry member includes a cutter configured to cut tape.

In an embodiment, the cutter comprises a blade, such as a serrated blade or a sliding blade, arranged along the protruding gantry member.

In an embodiment, the body defines the at least one race along a surface thereof, the at least one tape carriage defining a lug configured to engage said race complimentarily so that the at least one tape carriage is distally extendable from the body.

In an embodiment, the body defines a pair of races on opposite surfaces thereof, the at least one tape carriage engaged with said races in a telescoping manner.

In an embodiment, the jig assembly comprises a plurality of tape carriages slidably engaged with said body and each other in a telescoping manner.

In an embodiment, at least one tape carriage defines at least one race along a surface thereof, a further tape carriage defining a lug configured to engage said race complimentarily so that the further tape carriage is distally extendable from the at least one tape carriage.

In an embodiment, the protruding gantry members are arranged substantially transverse to the direction in which the at least one roll is unspoolable.

In an embodiment, the protruding gantry members are configured such that the cutting tool, such as scissors, are freely-passable between said gantry members to cut unspooled tape.

According to a second aspect of the invention there is provided a method of cutting adhesive tape, said method comprising the steps of:
providing an adhesive tape cutting jig assembly in accordance with the first aspect of the invention;
unspooling tape from at least one roll of tape onto the protruding gantry members; and
passing a cutting tool between said protruding gantry members to cut said unspooled tape to provide a plurality of lengths of tape simultaneously.

In an embodiment, the method comprises the step of slidably extending at least one tape carriage from the body.

In an embodiment, the method comprises the step of telescoping at least one tape carriage from another.

According to a further aspect of the invention there is provided an adhesive tape cutting jig assembly and an associated method of cutting adhesive tape, substantially as herein described and/or illustrated.

### BRIEF DESCRIPTION OF THE DRAWINGS

The description will be made with reference to the accompanying drawings in which:

FIG. 1 is a diagrammatic perspective-view representation of one possible embodiment of an adhesive tape cutting jig assembly, in accordance with aspects of the present invention;

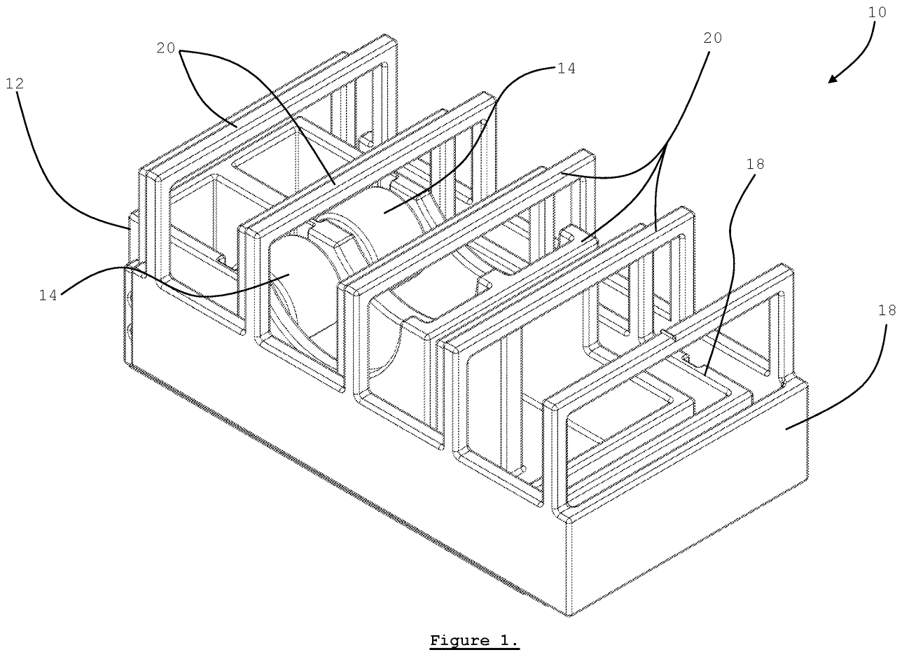

FIG. 2 is a diagrammatic exploded-view representation of the adhesive tape cutting jig assembly of FIG. 1;

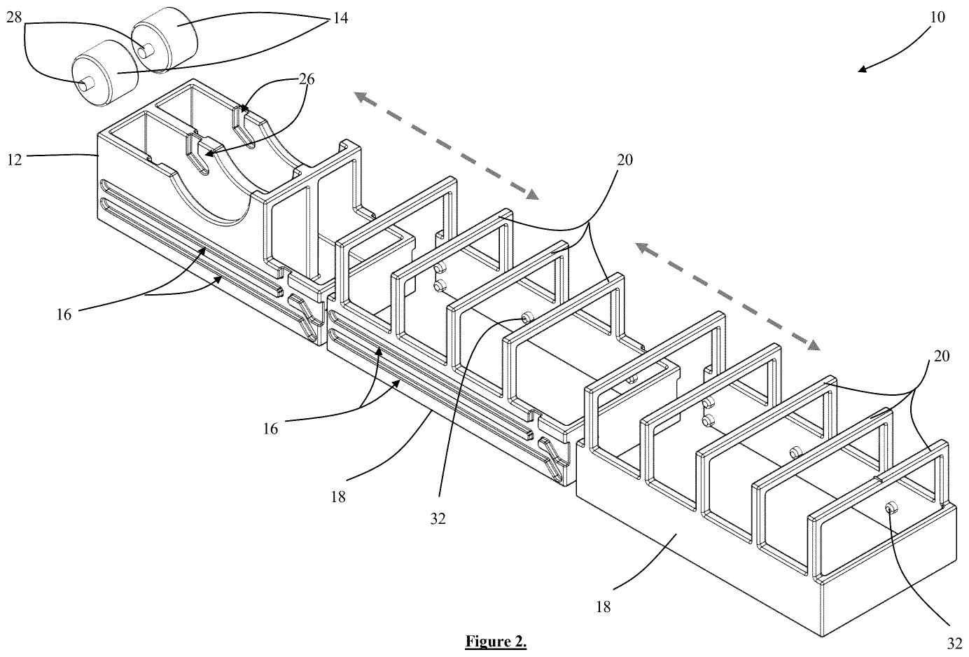

FIG. 3 is a further diagrammatic exploded-view representation of the adhesive tape cutting jig assembly of FIG. 1;

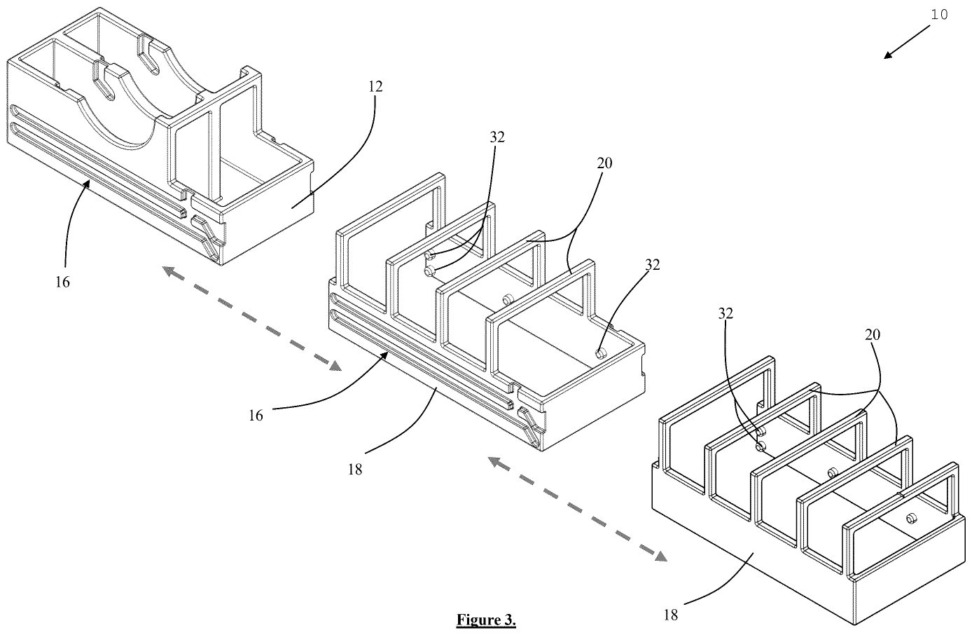

FIG. 4 is a diagrammatic perspective-view representation of a body of the assembly of FIG. 1;

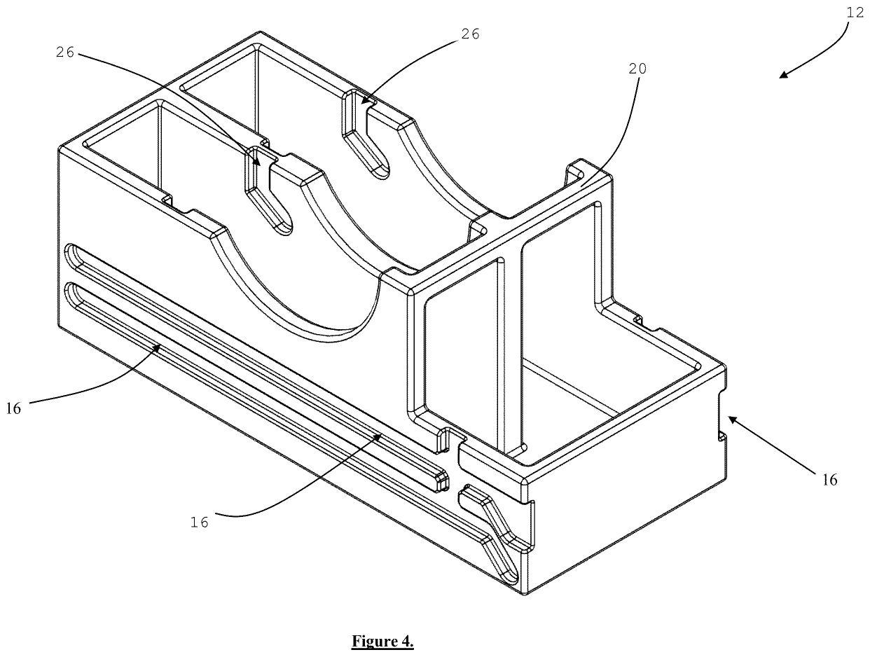

FIG. 5 is a diagrammatic perspective-view representation of a first tape carriage of the assembly of FIG. 1;

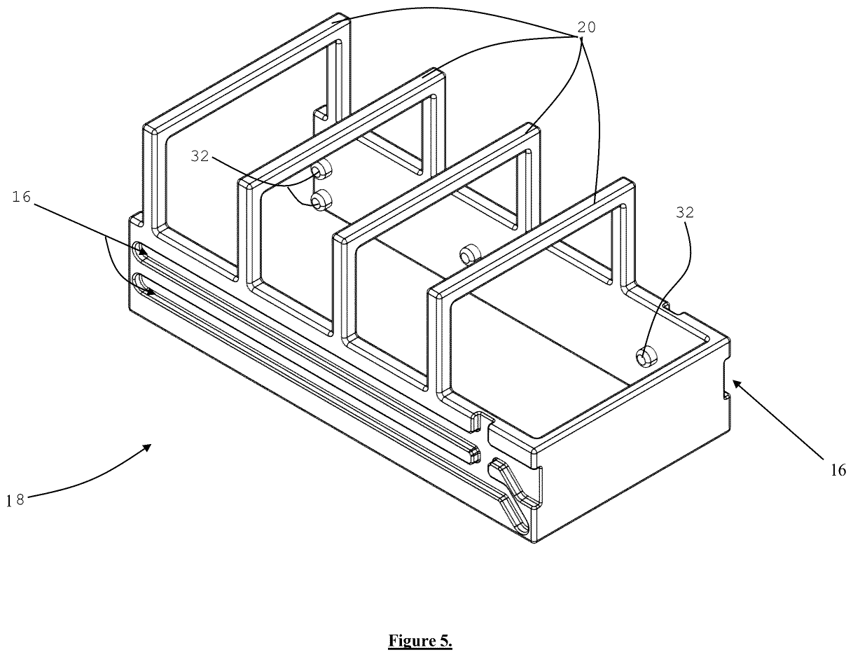

FIG. 6 is a diagrammatic perspective-view representation of a second tape carriage of the assembly of FIG. 1;

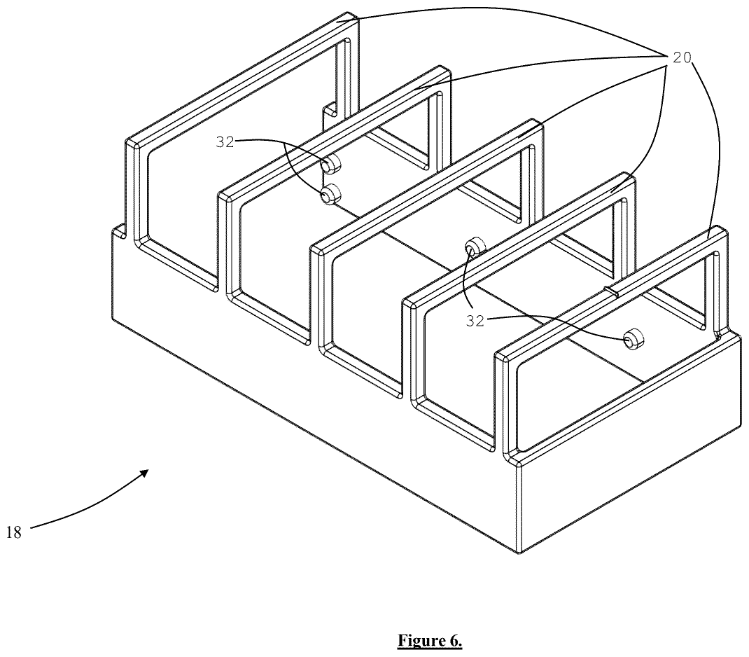

FIG. 7 shows respective front, sides and top representations of the body of FIG. 4;

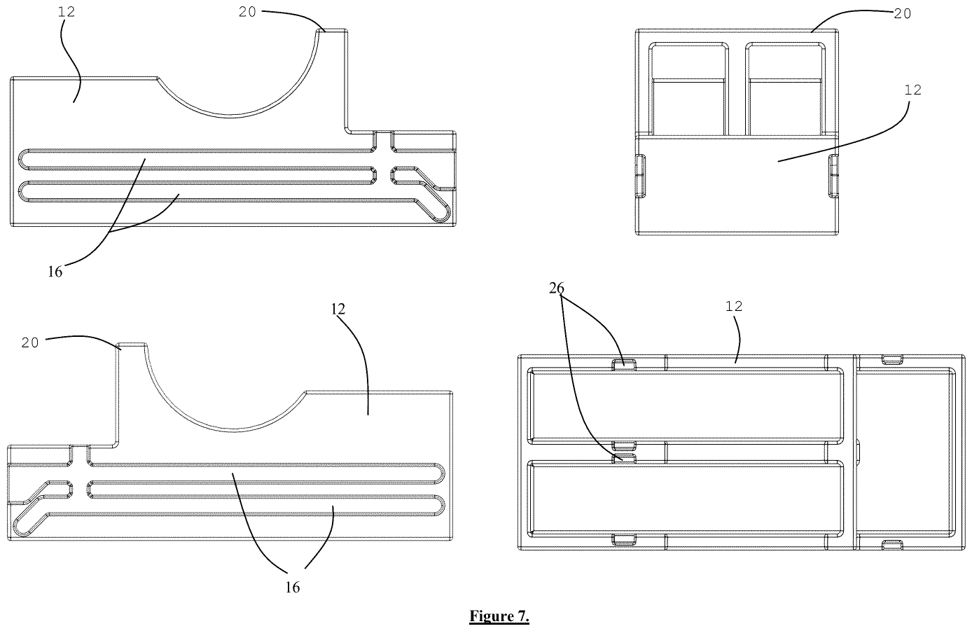

FIG. 8 shows respective front, sides and top representations of the first tape carriage of FIG. 5;

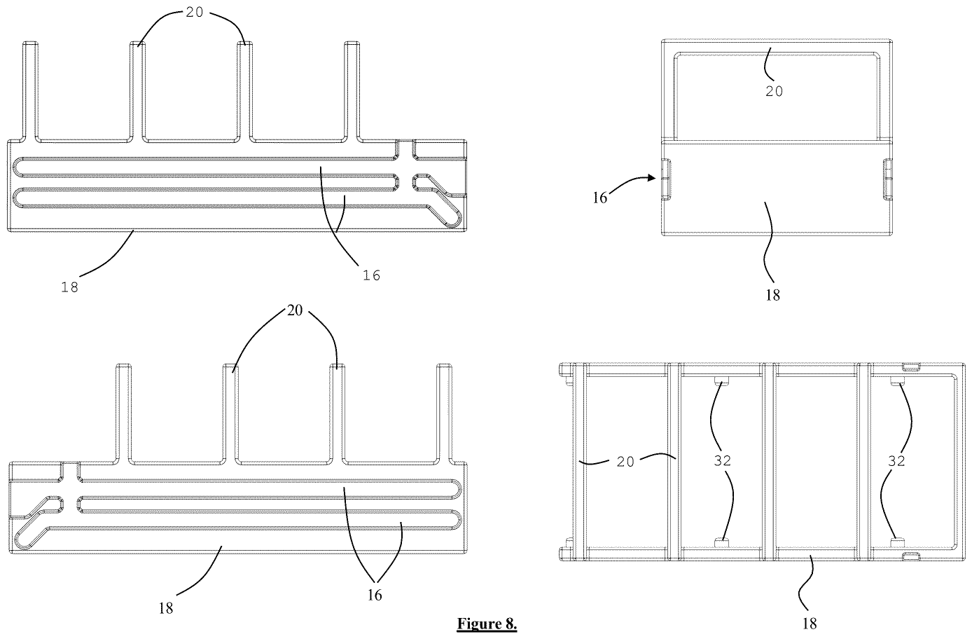

FIG. 9 shows respective front, sides and top representations of the second tape carriage of FIG. 6;

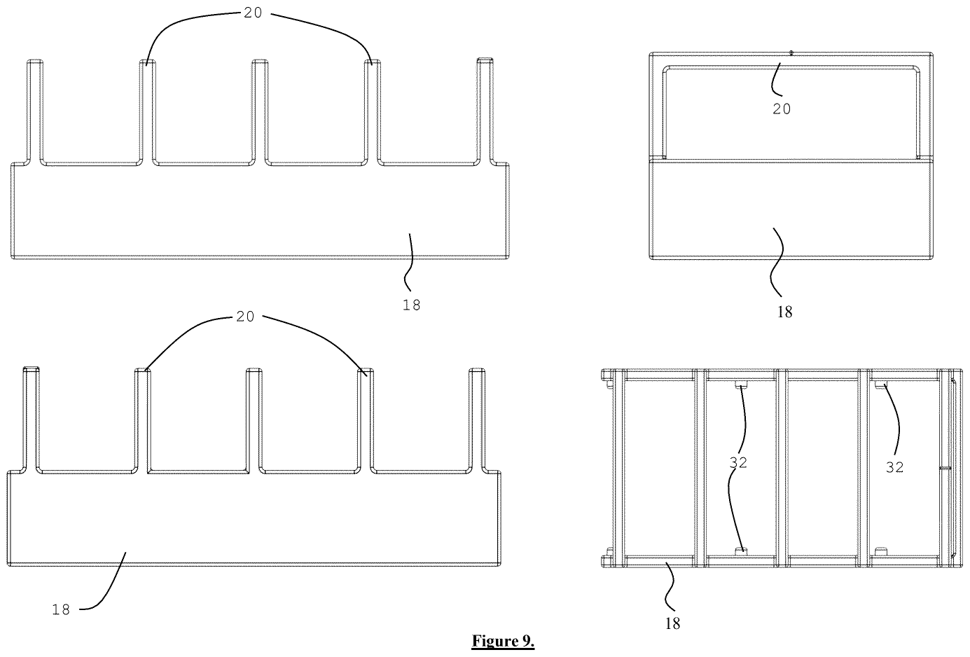

FIG. 10 is a diagrammatic top-overview representation of the adhesive tape cutting jig assembly of FIG. 1, being extended for use; and

FIG. 11 is a diagrammatic top-overview representation of the adhesive tape cutting jig assembly of FIG. 1 with tape carriages distally extended and tape adhered to gantry members for cutting.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

Additionally, the accompanying figures do not represent engineering or design drawings, but provide a functional overview of the invention only. As a result, features and practical construction details required for various embodiments may not be indicated in each figure, but such construction requirements will be within the understanding of the skilled addressee.

Broadly, the present disclosure provides for an adhesive tape cutting jig assembly 10 specifically configured to enable a plurality of lengths of adhesive tape to be positioned for cutting and accessing simultaneously. One possible embodiment of such a cutting jig assembly 10 is exemplified in the accompanying figures and broadly comprises a body 12 and at least one tape carriage 18, as described in more detail below.

The adhesive tape cutting jig assembly 10 typically comprises a body 12 which is configured to receive at least one roll of tape 14 rotatably therein and/or thereon. In one embodiment, the body 12 defines opposed slots 26 for receiving ends of a spindle 28 of a tape roll 14 therein, as shown, so that the roll 14 is rotatable to unspool the tape therefrom. In a typical embodiment, the body 12 is configured to receive a plurality of rolls of tape 14 arranged abreast.

The skilled addressee is to appreciate that various modifications or variations to the adhesive tape cutting jig assembly 10 are possible and within the principle of mechanical equivalence. For example, embodiments of assembly 10 may have one roll of tape 14, or it may have three or four (or more) rolls of tape 14 received within or on the body 12. Similarly, variations on the manner in which such roll(s) is received may vary, whilst allowing the same overall functionality.

For example, cutting jig assembly 10 may include suitable tape cores (representable via reference numerals 14 as well) with spindles 28 engageable with the body 12, with rolls of tape positionable about said tape cores 14. In such an embodiment, a user can urge a roll of tape about a tape core 14, such as via interference or friction fit, or the like. In another embodiment, the body 12 may comprise a platform whereon an existing or conventional tape dispenser is placeable or receivable, rather than the body 12 receiving such roll of tape directly. For example, the body 12 may be shaped and dimensioned with a receptacle for receiving a conventional tape dispenser with the tape unspoolable therefrom to lie across the protruding gantry members 20.

The body 12 generally defines at least one race, channel or similar track or guide extending along a direction in which said roll of tape 14 is unspoolable. Such race(s) 16 is for operative engagement by a tape carriage 18, as described in more detail below, to allow such tape carriage 18 to extend distally from the body 12.

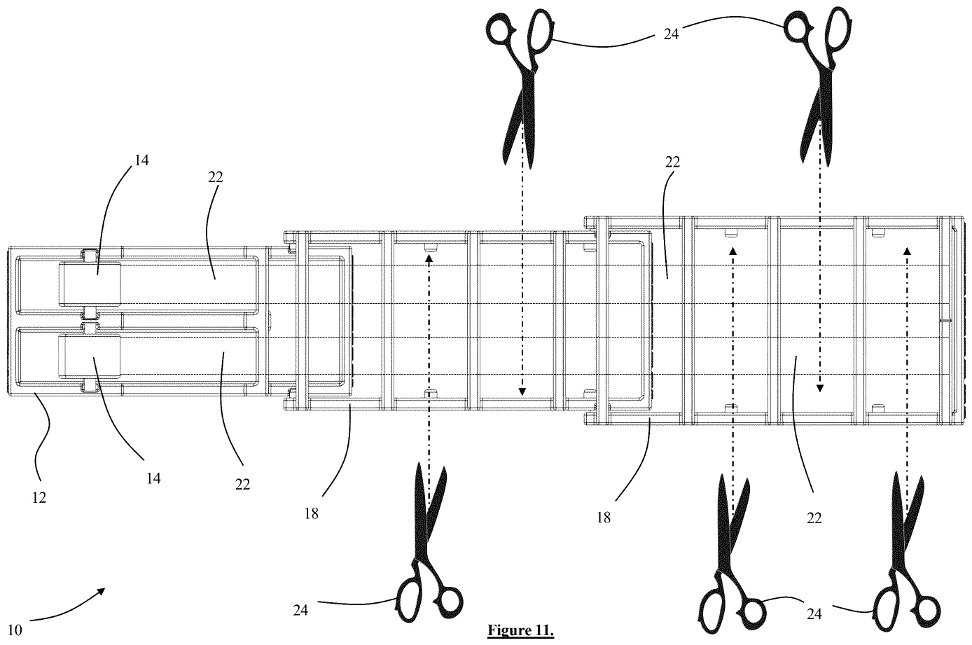

The adhesive tape cutting jig assembly 10 also includes a least one tape carriage 18 which is slidably engaged with the race 16 and arranged to extend distally from the body 12, typically being able to slide therefrom, in use. Importantly, the tape carriage 18 defines at least two protruding gantry members 20 on which the unspooled tape 22 is adherable, as shown in more detail in FIG. 11, so that a cutting tool 24, such as a pair of scissors, is freely-passable between the gantry members 20 to cut the unspooled tape 22 positioned or adhered on the gantry members 20 in order to provide a plurality of lengths of tape simultaneously.

In one embodiment, the body 12 defines the at least one race 16 along a surface thereof, with the at least one tape carriage 18 defining a lug 32 or similar engaging projection which is configured to engage said race 16 complimentarily so that the at least one tape carriage 18 is distally extendable from the body 12, i.e. the tape carriage 18 can be slid away from the body 12 without disengaging therefrom. In the exemplified embodiment, the body 12 defines a pair of races 16 on opposite surfaces thereof, the at least one tape carriage 18 engaged with said pair of races 16 in a telescoping manner, as shown.

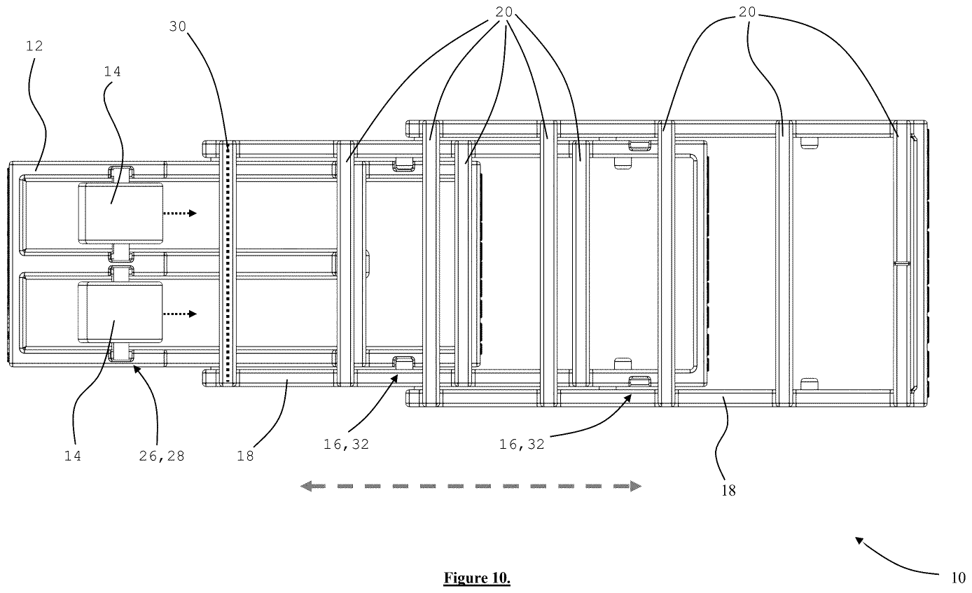

In the exemplified embodiment, the jig assembly 10 comprises two tape carriages 18, one of which is slidably engaged with the body 12 and the other of which is slidably engaged with the first tape carriage 18, as shown. In this manner, a plurality of tape carriages 18 may be engaged with the body 12 and each other in a telescoping manner. In such an embodiment, at least one tape carriage 18 defines at least one similar race 16 as that of the body 12 along a surface thereof, as shown, so that a further tape carriage 18 defining a similar lug 32 is configured to engage said race 16 complimentarily so that the further tape carriage 18 is distally extendable from the at least one tape carriage 18, as shown in more detail in FIG. 10.

In one embodiment, the protruding gantry members 20 are arranged substantially transverse to the direction in which the at least one roll 14 is unspoolable. In one embodiment, the body 12 also defines at least one protruding gantry member 20 on which unspooled tape 22 is receivable. In one embodiment, at least one protruding gantry member 20 includes a cutter 30 which is configured to cut tape. In one embodiment, the cutter 30 may comprise a blade, such as a serrated blade, or a sliding blade, or the like, arranged along the protruding gantry member 20. Such a cutter 30 may be arranged on any suitable gantry member 20, albeit on the body 12 and/or the carriage 18. Of course, variations hereon are possible and anticipated.

In a typical embodiment, the protruding gantry members 20 are configured such that the cutting tool 24, such as scissors, are freely-passable between said gantry members 20 to cut unspooled tape 22 positioned or adhered to the gantry members 20. Accordingly, the gantry members 20 may take various forms, such as protruding or extending pillars or beams of sufficient height to allow the cutting tool 24 to pass therethrough for cutting unspooled tape 24. Again, variations hereon are possible and within the scope of mechanical equivalence.

The skilled addressee is further to appreciate that the present invention includes an associated method of cutting adhesive tape. Such a method broadly comprises the steps of providing an adhesive tape cutting jig assembly 10, as described, unspooling tape from at least one roll of tape 14 onto the protruding gantry members 20, and passing a cutting tool 24 between said protruding gantry members 20 to cut said unspooled tape 22 to provide a plurality of lengths of tape simultaneously.

In one embodiment, the method comprises the step of slidably extending at least one tape carriage 18 from the body 12. In one embodiment, the method comprises the step of telescoping at least one tape carriage 18 from another. In this manner, one or more tape carriages 18 can be extended from the body 12 and each other, as relevant, with tape unspooled onto the protruding gantry members 20, so that the cutting tool 24 is able to cut a plurality of lengths of tape to be used for handiwork, such as wrapping presents, covering books, arts, craft, or the like.

Applicant believes it particularly advantageous that the present invention provides for simple, elegant and inexpensive means whereby a plurality of lengths of tape is simultaneously presentable to a user when engaged in handicrafts, such as wrapping presents, covering schoolbooks, arts, etc. The adhesive tape cutting jig assembly 10 is mechanically-simple to realise, inexpensive to manufacture, and allows a plurality of cut tape lengths to stay on the protruding gantry members 20 for use as and when required. The cutting jig assembly 10 can also be telescoped or folded away to reduce an overall footprint thereof for storage purposes.

In the example embodiments, well-known processes, well-known device structures, and well-known technologies are not described in detail, as such will be readily understood by the skilled addressee. Optional embodiments of the present invention may also be said to broadly consist in the parts, elements and features referred to or indicated herein, individually or collectively, in any or all combinations of two or more of the parts, elements or features. Where specific integers are mentioned herein which have known equivalents in the art to which the invention relates, such known equivalents are deemed to be incorporated herein as if individually set forth.

Various substantially and specifically practical and useful exemplary embodiments of the claimed subject matter are described herein, textually and/or graphically, for carrying out the claimed subject matter. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. It is to be appreciated that reference to “one example” or “an example” of the invention, or similar exemplary language (e.g., “such as”) herein, is not made in an exclusive sense.

Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or”includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the contrivance in use or operation in addition to the orientation depicted in the figures. For example, if the contrivance in the figures is turned over, elements described as “below” or “beneath” other elements or features would then be oriented “above” the other elements or features. Thus, the example term “below” can encompass both an orientation of above and below. The contrivance may be otherwise oriented (rotated 90 degrees or at other orientations) and the spatially relative descriptors used herein interpreted accordingly.

Any method steps, processes, and operations described herein are not to be construed as necessarily requiring their performance in the particular order discussed or illustrated, unless specifically identified as an order of performance. It is also to be understood that additional or alternative steps may be employed.

1. An adhesive tape cutting jig assembly comprising:
a body configured to receive at least one roll of tape rotatably thereby, said body defining at least one race extending along a direction in which said roll is unspoolable; and
at least one tape carriage slidably engaged with said race and arranged to extend distally from said body, in use, the tape carriage defining at least two protruding gantry members on which the unspooled tape is adherable so that a cutting tool is freely-passable between said gantry members to cut said unspooled tape to provide a plurality of lengths of tape simultaneously.

2. The assembly of claim 1, wherein the body defines opposed slots for receiving ends of a spindle of a tape roll therein so that the roll is rotatable to unspool the tape.

3. The assembly of either of claims 1 or 2, wherein the body is configured to receive plurality of rolls of tape arranged abreast.

4. The assembly of any of claims 1 to 3, wherein the body defines at least one protruding gantry member on which unspooled tape is receivable.

5. The assembly of any of claims 1 to 4, wherein at least one protruding gantry member includes a cutter configured to cut tape.

6. The assembly of claim 5, wherein the cutter comprises a blade, such as a serrated blade or a sliding blade, arranged along the protruding gantry member.

7. The assembly of any of claims 1 to 6, wherein the body defines the at least one race along a surface thereof, the at least one tape carriage defining a lug configured to engage said race complimentarily so that the at least one tape carriage is distally extendable from the body.

8. The assembly of claim 7, wherein the body defines a pair of races on opposite surfaces thereof, the at least one tape carriage engaged with said races in a telescoping manner.

9. The assembly of any of claims 1 to 8, which comprises a plurality of tape carriages slidably engaged with said body and each other in a telescoping manner.

10. The assembly of claim 9, wherein at least one tape carriage defines at least one race along a surface thereof, a further tape carriage defining a lug configured to engage said race complimentarily so that the further tape carriage is distally extendable from the at least one tape carriage.

11. The assembly of any of claims 1 to 10, wherein the protruding gantry members are arranged substantially transverse to the direction in which the at least one roll is unspoolable.

12. The assembly of any of claims 1 to 11, wherein the protruding gantry members are configured such that the cutting tool, such as scissors, are freely-passable between said gantry members to cut unspooled tape.

13. A method of cutting adhesive tape, said method comprising the steps of:
providing an adhesive tape cutting jig assembly in accordance with any one of claims 1 to 12;
unspooling tape from at least one roll of tape onto the protruding gantry members; and
passing a cutting tool between said protruding gantry members to cut said unspooled tape to provide a plurality of lengths of tape simultaneously.

14. The method of claim 13, which comprises the step of slidably extending at least one tape carriage from the body.

15. The method of claim 13, which comprises the step of telescoping at least one tape carriage from another.
